(19) United States
(12) Patent Application Publication
(10) Pub. No.: US 2021/0320331 A1
(43) Pub. Date: Oct. 14, 2021

(54) SOLID POLYMER MATRIX ELECTROLYTE (PME) FOR RECHARGEABLE LITHIUM BATTERIES AND BATTERIES MADE THEREWITH

(71) Applicant: BRIGHTVOLT, INC., Redmond, WA (US)

(72) Inventor: Anaba Anani, Bloomington, IN (US)

(21) Appl. No.: 17/266,485

(22) PCT Filed: Aug. 7, 2019
(86) PCT No.: PCT/US19/45495

§ 371 Date: Feb. 5, 2021

Related U.S. Application Data
(60) Provisional application No. 62/715,829, filed on Aug. 8, 2018.

(51) Int. Cl. H01M 10/0565; H01M 4/131; H01M 4/133; H01M 4/136; H01M 4/134; H01M 4/40; H01M 4/505; H01M 4/525; H01M 4/58; H01M 4/587; H01M 4/62; H01M 10/0525; H01M 10/0585

(52) U.S. Cl. CPC H01M 10/0565; H01M 4/131; H01M 4/133; H01M 4/136; H01M 4/134; H01M 4/405; H01M 2300/0082; H01M 4/525; H01M 4/5825; H01M 4/587; H01M 4/623; H01M 10/0525; H01M 10/0585; H01M 4/505

(57) ABSTRACT

A rechargeable lithium battery is provided. The battery includes an anode comprising an anode binder polymer and an anode active material, a cathode comprising a cathode binder polymer and a cathode active material and a polymer-matrix electrolyte (PME) comprising an electrolyte polymer, a lithium salt and an electrolyte solvent. The polymer-matrix electrolyte is positioned between the anode and the cathode and directly contacts the anode and cathode to form a battery cell. The polymer-matrix electrolyte interpenetrates into the adjacent anode and cathode to form an integral structure.

### CROSS-REFERENCE TO RELATED PATENT APPLICATIONS

The present application claims priority to U.S. Provisional Patent Application Ser. No. 62/715,829, filed Aug. 8, 2018, the disclosure of which is incorporated herein as if set out in full.

### BACKGROUND

### Technical Field

This application relates generally to lithium battery technology and, in particular, to improved solid electrolytes for rechargeable lithium batteries and batteries made therewith.

### Background of the Technology

Lithium battery technology is the subject of intensive research. The main battery characteristics sought to be improved by new research are size, weight, energy density, capacity, lower self-discharge rates, cost, fast charging and environmental safety. The goal is to simplify the fabrication techniques and improve interlayer adhesion to produce a dry cell battery that is small and light weight, has a long useful life, has greater energy density, and contains little or no toxic compounds that may enter the environment upon disposal. Lithium batteries are useful for many applications such as power supplies for cellular phones, smart cards, calculators, portable computers, and electrical appliances. Lithium batteries can also be used in hybrid electric vehicles (HEVs) and battery electric vehicles (EVs).

Accordingly, there still exists a need for lithium batteries with improved characteristics, including energy density, capacity, lower self-discharge rates, cost, fast charging and environmental safety.

### SUMMARY

A rechargeable lithium battery is provided which comprises:

an anode comprising an anode binder polymer-matrix electrolyte (PME) and an anode active material;

a cathode comprising a cathode binder polymer-matrix electrolyte (PME) and a cathode active material; and

a polymer-matrix electrolyte (PME) comprising, at least an electrolyte polymer, a lithium salt and an electrolyte solvent or plasticizer;

wherein the polymer-matrix electrolyte is between the anode and the cathode and directly contacts the anode and cathode to form a battery cell; and

wherein the polymer-matrix electrolyte interpenetrates into the adjacent anode and cathode to form an integral structure.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a perspective view of a battery accord to the present invention.

FIG. 2 is a cross-sectional view of the battery of FIG. 1 taken along line II-II.

FIG. 3 shows an assembly process for forming an electrochemical bi-cell which is ready for packaging, according to an embodiment of the invention.

FIG. 4A is a schematic showing an electrode for a battery comprising particles of an electrode active material and particles of a conductive additive dispersed in a polymer matrix electrolyte (PME) comprising a lithium salt, a polymer and a solvent or plasticizer for the lithium salt.

FIG. 4B is a schematic showing an electrode as depicted in FIG. 4A integrated with a separator layer of polymer matrix electrolyte (PME) without electrode active material and a conductive additive.

FIG. 4C is a schematic showing the electrode/separator assembly of FIG. 4B integrated with a second electrode for a battery wherein the second electrode comprises particles of an electrode active material and particles of a conductive additive dispersed in a polymer matrix electrolyte (PME) comprising a lithium salt, a polymer and a solvent or plasticizer for the lithium salt.

FIG. 4D is a schematic showing the electrode/separator assembly of FIG. 4B integrated with an active metal electrode layer.

### DETAILED DESCRIPTION

As used herein, the term “about” when used to modify a numerical value means a value that is within 10% of that numerical value (i.e., +/−10%).

The batteries of the present invention exhibit excellent interlayer adhesion, are environmentally safe, and contains PME with high ionic conductivity over a range of temperatures and pressures, as illustrated in the below Table 1.

TABLE 1

| Temper- | Films Ionic | Typical |
|---|---|---|
| ature | Conductivity (S/cm) | Conductivity |
| (° C.) | PME | Ranges |
| −30 | 1.0 * 10⁻³ | 0.1 * 10⁻³ S/cm-2.0 * |
| −20 | 1.3 * 10⁻³ | 10⁻³ S/cm @ −30° C.) |
| −10 | 1.7 * 10⁻³ | 8.0 * 10⁻³ S/cm-1.2 * |
| 0 | 2.2 * 10⁻³ | 10⁻² S/cm @ +90° C.) |
| 20 | 3.3 * 10⁻³ | |
| 30 | 4.0 * 10⁻³ | |
| 40 | 4.7 * 10⁻³ | |
| 50 | 5.5 * 10⁻³ | |
| 60 | 6.0 * 10⁻³ | |
| 80 | 7.5 * 10⁻³ | |
| 90 | 8.3 * 10⁻³ | |

The batteries comprise at least one anode, at least one cathode, and at least one electrolyte disposed between each anode and each cathode. The batteries can be thin film batteries which are flexible. The anode, cathode, and electrolyte can be applied as very thin layers, or layers less than 1 mil in thickness. Because of this capability, the anode, cathode and electrolyte can be stacked in multiple layers. In addition, the components of the batteries described herein may be arranged in various combinations including: 1) an anode, an electrolyte, and a cathode; 2) two anodes, two electrolytes, and one cathode; 3) two cathodes, two electrolytes, and one anode; 4) a plurality of anodes, a plurality of electrolytes, and a plurality of cathodes; or 5) a bipolar configuration such that one cathode is folded around an anode, which has been surrounded by the electrolyte. The configuration chosen is dependent upon the desired application for the battery.

According to some embodiments, a solid-state polymer matrix electrolyte (PME) for secondary (i.e., rechargeable) lithium batteries is provided. The polymer matrix electrolyte (PME) comprises at least a solvent or plasticizer, polymer and a lithium salt. The PME is not a liquid or gel but rather is a solid-state material. Moreover, unlike conventional gel or liquid electrolytes, all of the PME components (i.e., solvent, polymer and a lithium salt) participate in ionic conduction as well as providing mechanical support.

According to some embodiments, the PME is bonded directly to the cathode thus enabling thinner layers, eliminating dead space and providing higher energy density. A battery can be assembled by combining the PME/cathode assembly with an anode. Two component assembly can simplify battery manufacture compared to conventional three component assembly. According to some embodiments, the PME interpenetrates into the adjacent anode and cathode structure to form a battery having a continuous structure. The PME acts as an adhesive between the anode and cathode. This interpenetrating structure reduces interfacial resistances and impedances.

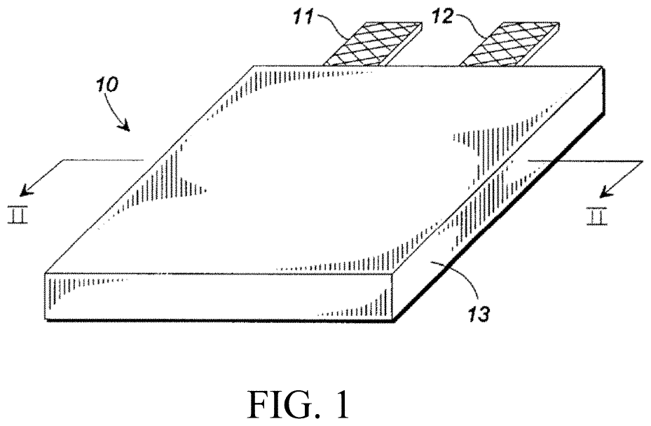

Batteries comprising the PME can be used in various configurations. FIG. 1 shows an exemplary configuration for the battery 10 comprising an anode current collector 11 and a cathode current collector 12 protruding from the main body portion of the battery for connection to the desired circuitry and for delivery of the voltage and current or recharge of the battery. As shown in FIG. 1, the main body portion is encased in a cover film 13, which can be a single or multi-layer film which can be impermeable to gases or liquid. Preferably, the cover film is a very thin, high barrier, laminated foil film of a type which is suitable for the application and is easily processable with regard to formation of the battery. These cover films are well known in the art and include, but are not limited to, materials such as KAPAK KSP-150 or KSP-120 tri-laminate film produced by Kapak, Inc. Alternatively, multi-layer 48-gauge PET/LDPE/0.000285 foil film produced by Sealright Flexible Packaging Group may also be used.

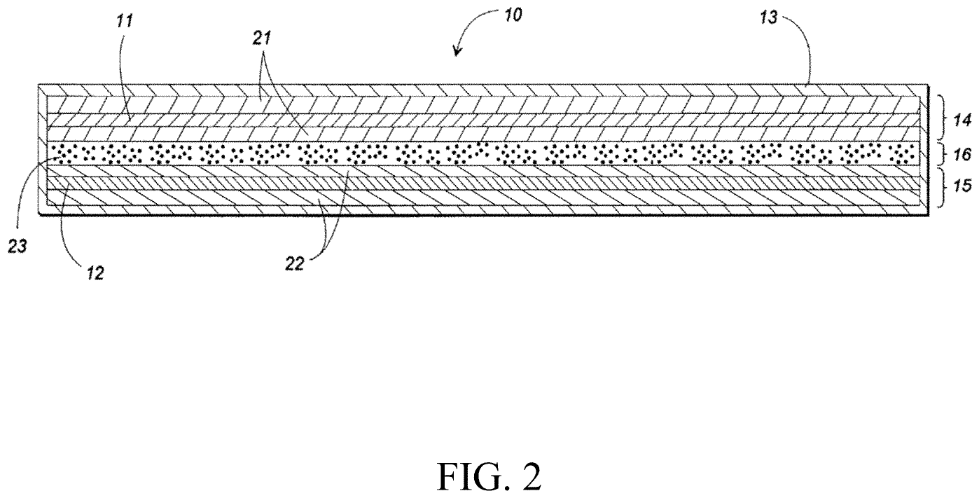

Referring now to FIG. 2, a representational cross-section of the battery 10 of FIG. 1 along line II-II is presented. As shown in FIG. 2, each anode 14 comprises an anode current collector 11. The anode 14 also may comprise a first PME, an electronic conductive filler and an intercalation material. The anode current collector 11 may be prepared from any material known to those skilled in the art. According to some embodiments, the anode current collector 11 is an electrically conductive member made of a metal. Exemplary, non-limiting examples of metals that can be used include copper. According to some embodiments, the anode current collector 11 is a thin (e.g., approximately 0.25-1.0 mil) expanded foil having regular apertures therein, such as found in a mesh or screen. As shown in FIG. 1, a first portion of the anode current collector 11 can extend from the main body of the battery 10 to provide an external connection means, while a second portion of the anode current collector 11 is situated within the cover 13 and encased in an anode composite material 21.

According to some embodiments, the anode composite material 21 can comprise an anode binder PME, an electronic conductive filler, and an intercalation material. The anode binder PME may have the same chemical composition as or have a different chemical composition than the cathode binder PME and the PME which are used in the cathode and the electrolyte, respectively. Any electronic conductive filler known to those skilled in the art may be blended with the anode binder PME, the anode active material, and a solvent to form a slurry. Examples of the electronic conductive filler include but are not limited to: conductive carbon, carbon black, graphite, graphite fiber, and graphite paper. In addition to the electronic conductive filler, an intercalation material may also form a part of the anode. Any intercalation material known to those skilled in the art may be used. Exemplary non-limiting examples of intercalation materials include: carbon, activated carbon, graphite, petroleum coke, a lithium alloy, nickel powder, and a low voltage lithium intercalation compound. As an alternative embodiment, the anode may further comprise a lithium salt. Any lithium salt known to those skilled in the art may be used but in particular those selected from the group consisting of: LiCl, LiBr, LiI, Li(ClO4), Li(BF4), Li(PF6), Li(AsF6), Li(CH3 CO2), Li(CF3 SO3), Li(CF3 SO2)2 N, Li(CF3 SO2)3, Li(CF3 CO2), Li(B(C6 H5)4), Li(SCN), LiBOB, and Li(NO3). Most preferably, the lithium salt is Li(PF6). Addition of the lithium salt to the anode can result in increased ionic conductivity.

As shown in FIG. 2, the cathode 15 comprises a cathode current collector 12. As with the anode current collector, a portion of the cathode current collector 12 extends from the main body of the battery 10 to provide an external connection means. However, a portion of the cathode current collector 12 is situated within the cover 13 and is encased within a cathode composite material 22. The cathode current collector 12 is any cathode current collector known to those skilled in the art. Exemplary cathode current collector materials include a thin (e.g., ranging from about 0.25-1.0 mil) expanded metal foil having apertures therein. The metal can be aluminum. The apertures are usually of a regular configuration such as that found in a mesh or screen. The cathode composite material 22 may comprise at least a cathode binder PME, an electronic conductive filler, and a cathode active material. The cathode binder PME may or may not be of the same chemical composition as the anode binder and electrolyte PMEs which are used in the anode and the electrolyte, respectively. Any electronic conductive filler known to those skilled in the art may be blended with the cathode binder and a solvent or plasticizer to form a slurry. Examples of such electronic conductive fillers include, but are not limited to: conductive carbon, carbon black, graphite, graphite fiber, and graphite paper. In addition, the cathode comprises a metal oxide or other cathode active material(s). Any metal oxide known to those skilled in the art may be used. Exemplary metal oxides include, but are not limited to: LiCoO2; LiMnO2; LiNiO2; V6O13; V2O5; and LiMn2O4. Other complex lithiated metal oxides can also be used including, but not limited to, Li—Ni—Mn—Co oxides with Ni, Mn, and Co ratios totaling 1. According to some embodiments, the cathode may further comprise one or more lithium salts. Any lithium salt known to those skilled in the art may be used. Exemplary lithium salts include, but are not limited to: LiCl, LiBr, LiI, Li(ClO4), Li(BF4), Li(PF6), Li(AsF6), Li(CH3 CO2), Li(CF3 SO3), Li(CF3 SO2)2 N, Li(CF3 SO2)3, Li(CF3 CO2), Li(B(C6 H5)4), Li(SCN), LiBOB, and Li(NO3). As with the anode, addition of a lithium salt to the cathode can result in an increase in ionic conductivity.

As shown in FIG. 2, a PME 16 is disposed between the anode 14 and the cathode 15. The PME 16 comprises at least an electrolyte polymer and a lithium salt 23. The electrolyte polymer may or may not be of the same chemical composition as the anode and cathode binder polymers used in the anode and the cathode, respectively. The lithium salt used in the electrolyte can be any lithium salt known to those skilled in the art. Exemplary lithium salts include, but are not limited to: LiCl, LiBr, LiI, Li(ClO4), Li(BF4), Li(PF6), Li(AsF6), Li(CH3 CO2), Li(CF3 SO3), Li(CF3 SO2)2 N, Li(CF3 SO2)3, Li(CF3 CO2), Li(B(C6 H5)4), Li(SCN), LiBOB, and Li(NO3).

The chemical compositions of the anode binder, cathode binder and electrolyte polymers may exist in various combinations. According to some embodiments, anode binder, cathode binder and electrolyte polymers may be the same. Alternatively, other combinations may exist such as: 1) the anode binder and cathode binder polymers are the same and the electrolyte polymer is a different polymer; 2) the anode binder and electrolyte polymers are the same and the cathode binder polymer is a different polymer; 3) the cathode binder and electrolyte polymers are the same and the anode binder polymer is a different polymer; or 4) the anode binder, cathode binder, and electrolyte polymers are different polymers.

A method of making a battery as described herein is also provided. According to some embodiments, an anode slurry comprising the first PME solution, an electronic conductive filler, and an intercalation material is prepared. The first PME solution can be prepared by mixing a first polymer with a solvent. An ionic liquid (i.e., a lithium salt solution comprising a lithium salt and a solvent or plasticizer) can optionally be added to the first polymer solution. According to some embodiments, the first PME solution can be prepared by mixing about 8% to about 20% by weight of the first polymer with about 8% to about 20% of the salt and solvent/plasticizer and about 60% to about 84% by weight of a solvent.

A cathode slurry comprising a second PME solution; an electronic conductive filler; and an active cathode material or a metal oxide is prepared. The second polymer solution can be prepared by mixing a second polymer with a solvent. According to some embodiments, the second PME solution can be prepared by mixing about 8% to about 20% by weight of the second polymer with about 80% to about 92% by weight of a solvent. A lithium salt may be optionally added to the second polymer solution.

A polymer matrix electrolyte (PME) solution comprising a third polymer and a lithium salt is prepared. The PME solution is prepared by mixing a third polymer with a solvent. According to some embodiments, the third polymer solution can be prepared by mixing about 8% to about 20% by weight of the third polymer with about 80% to about 92% by weight of a solvent. A lithium salt is dissolved in a solvent or plasticizer to form a lithium salt solution. According to some embodiments, about 20% to about 35% by weight of a lithium salt is dissolved in about 65% to about 80% by weight of a solvent to form the lithium salt solution. The lithium salt solution is then mixed with the third polymer solution to form the PME solution. According to some embodiments, the PME solution can comprise from about 2% by weight to about 10% by weight of the third polymer and from about 1% by weight to about 12% by weight of the lithium salt.

According to some embodiments, a polymer matrix electrolyte (PME) layer can be formed by casting a film of the PME solution. The PME film can be cast using standard thin film methodology, such as spin casting or using a doctor blade to draw down the solution to a film ranging from about 0.25 mils to about 20 mils in thickness. The electrolyte layer can then be dried using any method known to those skilled in the art. Exemplary and non-limiting drying methods include drying in an oven at about 70 to about 150° C. for about 20 to about 60 minutes to drive off the solvent. The electrolyte layer can be fully dried in an oven at about 150° C. for about 30 to 60 minutes.

An anode can be formed by coating the anode slurry on a first current collector. Any coating technique known to those skilled in the art may be used provided it is not laminating. Such coating techniques include but are not limited to: vapor deposition, dip coating, spin coating, screen coating, and coating with a brush. According to some embodiments, no preparation of the current collector is required. The anode slurry can be applied to the first current collector at a relatively thin layer. The anode slurry can be dried using any method known to those skilled in the art and, in particular, in a gravity flow oven for about 20 to about 60 minutes at approximately 70 to 150° C. to drive off the solvent and leave a tacky film. Preferably, the anode can be fully dried in an oven at about 150° C. for about 30 to 60 minutes. As set forth above, the salt can be incorporated into the anode slurry that comprises the PME binder. Alternatively, the anode can be loaded with lithium ions by soaking the anode in a lithium salt solution (e.g., a 1 Molar Li salt solution for about 20 to about 45 minutes). The lithium salt solution can be a lithium salt dissolved in a 50/50 blend of ethylene carbonate (EC)/propylene carbonate (PC). After the anode is finished soaking, it can be wiped dry to remove the excess solution.

The cathode can be formed by coating the cathode slurry on a second current collector. Any coating technique known to those skilled in the art may be used. Such coating techniques include but are not limited to: vapor deposition, dip coating, spin coating, screen coating, and coating with a brush. As with the anode, no preparation of the current collector is required. The cathode slurry can be applied to the second current collector at a relatively thin layer. The cathode can be dried using any method known to those skilled in the art and, in particular, in an oven for about 20 to about 60 minutes at approximately 70 to 150° C. to drive off the solvent and leave a tacky film. The cathode can be fully dried in an oven at about 150° C. for about 30 to 60 minutes.

The anode, electrolyte layer and the cathode are assembled to form a battery. The assembly process can take place using several methods. According to some embodiments, electrolyte solution is applied to a surface of the anode and the electrolyte layer is positioned over the anode such that the electrolyte solution is disposed therebetween. Electrolyte solution can then be applied to the side of the electrolyte layer opposite the anode or to the underside of the cathode. The cathode can then be positioned over the side of the electrolyte layer opposite the anode such that electrolyte solution is disposed between the cathode and electrolyte layer to form a battery assembly. The assembly can then be heated at a temperature sufficient to allow the electrolyte solution to dry and wherein each of the first, second and third polymers undergoes softening or melt flow. The softening of the polymer allows for intimate lateral contact to take place between the layers, ultimately forming a uniform assembly which is self-bonded and exhibits excellent adhesion between the interlayers. After the assembly is heated, it can be cooled to room temperature. As an additional step, the assembly can be placed in a protective casing and charged using a constant voltage or constant current.

As an alternative method for assembly, the electrolyte layer, the anode and the cathode can be dried to a tacky state. The battery can then be assembled by providing the anode, positioning the electrode layer over the anode, and positioning the cathode over the electrolyte layer to form an assembly. Pressure can then be applied to the assembly. The amount of pressure applied may be as minimal as merely pressing the layers together by hand or by applying pressure in a press. The amount of pressure required should be sufficient to allow for intimate contact to be made between the layers. In an optional additional step, the assembly can be heated to a temperature wherein each of the first, second and third polymers undergoes melt flow. The assembly can then be cooled to room temperature. The assembly can then be enclosed in a protective casing and charged using a constant voltage or constant current. The PME batteries resulting from this process exhibit excellent interlayer adhesion, are flexible, and exhibit ionic conductivity over a range of temperatures.

According to some embodiments, a two-component battery assembly process is provided. The two-component assembly comprises overcoating an electrode with a PME to form an electrode/separator and subsequent assembly with an anode. For the two-component battery assembly, a cathode slurry comprising cathode active material and cathode polymer binder is mixed in a bulk solvent. The cathode slurry can be coated upon a metal current collector substrate and the solvent removed (e.g., via drying). Subsequently, the coated cathode can be overcoated with a PME comprising a mixture of electrolyte polymer, lithium salt and solvent, and then dried to remove solvent with an effective amount of solvent retained for conductivity purposes, such as 5 to 50 weight % versus polymer(s) plus lithium salt. At this point the overcoated cathode has become both the cathode and the PME separator. An anode layer can then be placed over the PME coated cathode, thus providing a battery assembly manufactured from two components.

In another embodiment of a 2-component battery assembly process, the coated anode can be overcoated with a PME to form an anode/separator ensemble. A cathode layer can then be placed over the PME coated anode, thus providing a battery assembly manufactured from two components

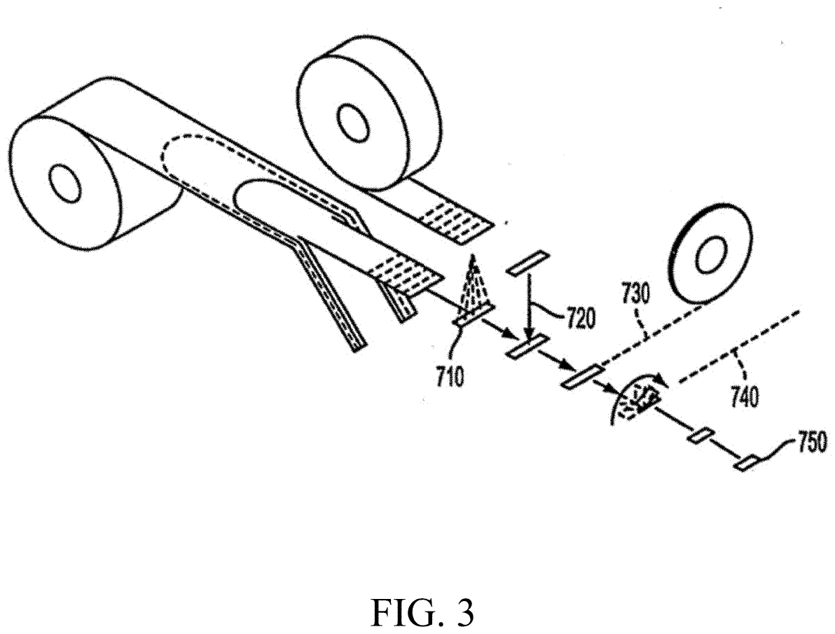

FIG. 3 shows an assembly “folding” process related to one of the two-component battery assembly process described above. A PME coated cathode on a cathode current collector is first provided as described above. Prior to placing the anode on the PME separator/cathode, in step 710 the surface of the PME overcoated cathode is sprayed with a small amount of solvent for adhesion and cell activation purposes. In step 720 a Li anode, such as a Li metal strip is then placed on the PME coated cathode. Alternatively, for a graphitic anode, the anode could also be coated, dried, then overcoated on the PME coated cathode. An anode tab, such as a nickel tab, is then placed on the anode in step 730. A cell fold is then performed in step 740 by wrapping the PME coated anode over the cathode as shown in FIG. 7 to form a bi-cell battery having an anode tab 750 which is ready for packaging. Bi-cells provide twice the capacity of conventional cells while having the same footprint of the conventional cell. A cathode tab (not shown) can then be placed on the cathode.

Although a bi-cell is shown in FIG. 3, the cell does not have to be in a bi-cell configuration. Other exemplary and non-limiting configurations include a single cell with single anode/PME/cathode layers; a “jellyroll” configuration in which the anode/PME/cathode assembly is wound into roll or a stacked configuration in which multiple anode/PME/cathode assemblies are stacked together to form a multi-layer cell.

The resulting cell can then be placed between upper and lower packaging material which can be sealed around the perimeter of the battery cell to form the packaged battery.

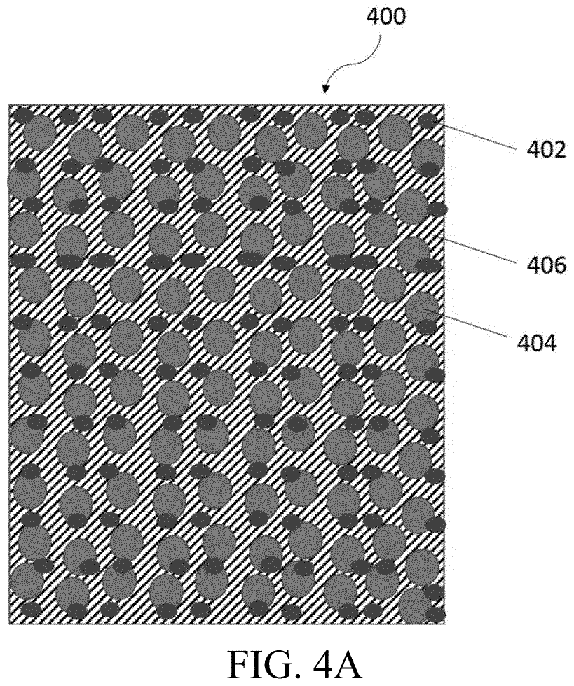

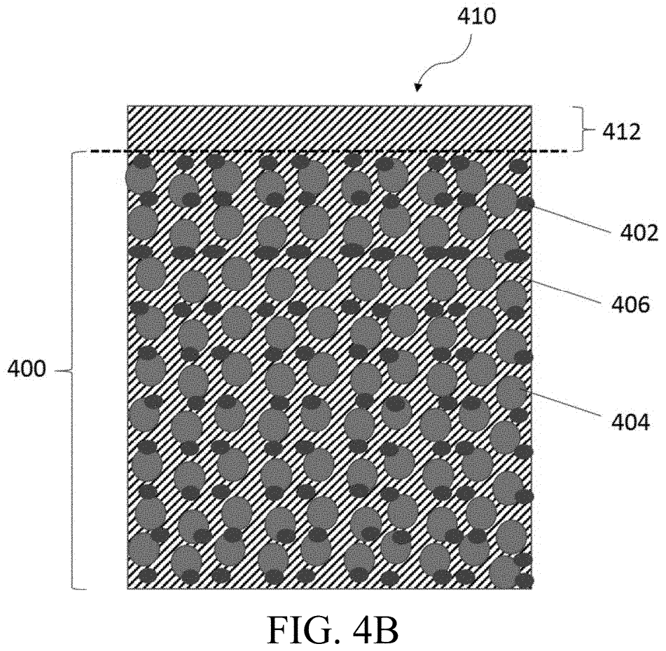

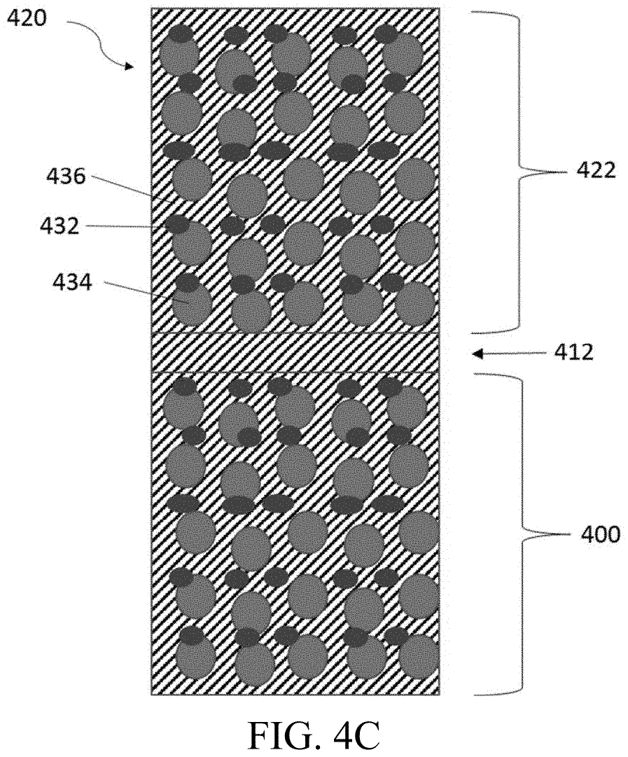

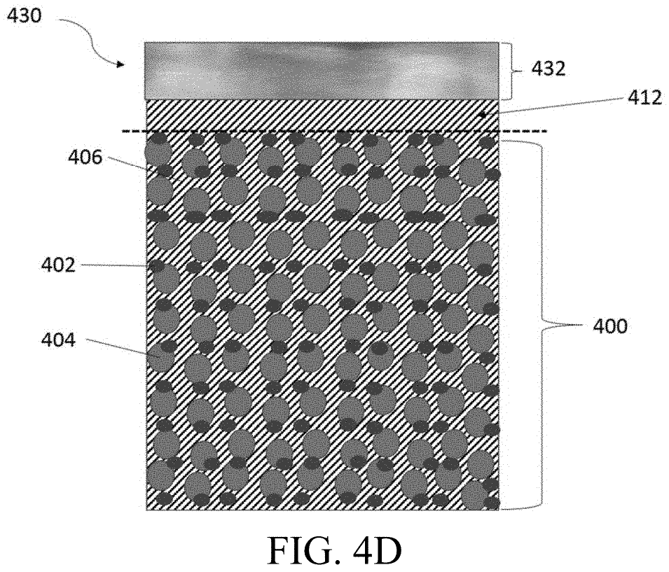

FIG. 4A is a schematic showing an electrode 400 for a battery comprising particles of an electrode active material 404 and particles of a conductive additive 402 dispersed in a polymer matrix electrolyte (PME) 406. The PME can comprise a lithium salt, a polymer and a solvent or plasticizer for the lithium salt.

FIG. 4B is a schematic showing an electrode/separator assembly 410 comprising an electrode 400 as depicted in FIG. 4A integrated with a separator layer 412 of polymer matrix electrolyte (PME) that does not contain electrode active material or a conductive additive.

FIG. 4C is a schematic of a battery 420 comprising the electrode 400 and separator 412 of FIG. 4B integrated with a second electrode 422 wherein the second electrode comprises particles of an electrode active material 434 and particles of a conductive additive 432 dispersed in a polymer matrix electrolyte (PME) 436. The PME can comprise a lithium salt, a polymer and a solvent or plasticizer for the lithium salt.

FIG. 4D is a schematic of a battery 430 showing the electrode 400 and separator 412 of FIG. 4B integrated with an active metal electrode layer 432.

According to some embodiments, a solid polymer matrix electrolyte (PME) is provided which is formed by one or more polymer host as a solid matrix along with one or more Li salts. Exemplary polymer hosts for the electrolyte include, but are not limited to: poly(ethylene oxide) (PEO), poly(propylene oxide) (PPO), poly(acrylonitrile) (PAN), poly(methyl methacrylate) (PMMA), poly(vinyl chloride) (PVC), poly(vinylidene fluoride) (PVdF), poly(vinylidene fluoride-hexafluoro propylene) (PVdF-HFP), polyimide (PI), polyurethane (PU), polyacrylamide (PAA), poly(vinyl acetate) (PVA), polyvinylpyrrollidinone (PVP), Poly(ethylene glycol) diacrylate (PEGDA), polyester (PET), polypropylene (PP), polyethylene napthalate (PEN), polycarbonate (PC), polyphenylene sulfide (PPS), and polytetrafluoroethylene(PTFE), or a combination of two or more thereof the specific polymer to achieve a balance property among ionic conductivity, mechanical strength, thermo-stability and electrochemical window by a polymer blending or copolymerization technique.

The polymer electrolyte comprises an electrolyte salt, an electrolyte polymer and an electrolyte solvent in which the electrolyte salt is dissolved. Examples of the electrolyte polymer include but are not limited to ether-based polymers such as polyethylene oxide and cross-linked polyethylene oxide, polymethacrylate ester-based polymers, acrylate-based polymers and the like. These polymers may be used alone, or in the form of a mixture or a copolymer of two kinds or more.

According to some embodiments, the electrolyte polymer can be a fluorocarbon polymer. Exemplary non-limiting examples of fluorocarbon polymers include polyvinylidene fluoride (PVDF), polyvinylidene-co-hexafluoropropylene (PVDF-HFP) and the like.

According to some embodiments, the electrolyte polymer can be a polyacrylonitrile or a copolymer of a polyacrylonitrile. Non-limiting examples of monomers (vinyl based monomers) used for copolymerization with acrylonitrile include but are not limited to: vinyl acetate, methyl methacrylate, butyl methacylate, methyl acrylate, butyl acrylate, itaconic acid, hydrogenated methyl acrylate, hydrogenated ethyl acrylate, acrlyamide, vinyl chloride, vinylidene fluoride, and vinylidene chloride.

According to some embodiments, the polymer compound used for the polymer electrolyte can be polyphenylene sulfide (PPS), poly(p-phenylene oxide) (PPO), liquid crystal polymers (LCPs), polyether ether ketone (PEEK), polyphthalamide (PPA), polypyrrole, polyaniline, and polysulfone. Co-polymers including monomers of the listed polymers and mixtures of these polymers may also be used. For example, copolymers of p-hydroxybenzoic acid can be appropriate liquid crystal polymer base polymers such as poly(vinyl acetal), poly(acrylonitrile), poly(vinyl acetate), polyester (PET), polypropylene (PP), polyethylene napthalate (PEN), polycarbonate (PC), polyphenylene sulfide (PPS), and polytetrafluoroethylene (PTFE), or a combination of two or more thereof. The specific polymer of the latter group and its concentration in the blend are selected to tailor at least one desired property of the base polymer material.

According to some embodiments, the base polymer material may include other substances such as an acrylate, polyethylene oxide (PEO), polypropylene oxide (PPO), poly(bis(methoxy-ethoxy-ethoxide))-phosphazene (MEEP), polyacrylonitrile (PAN), polymethylmethacrylate (PMMA), polymethyl-acrylonitrile (PMAN), etc.

According to some embodiments, the electrolyte polymer material may include a polymer having a basic group such as an amino group. The electrolyte polymer can include a polyvinyl-series compound and a polyacetylene-series polymer compound.

According to some embodiments, the base polymer material for the electrolyte may comprise a polyimide polymer. Suitable polyimide polymers are described in: U.S. Pat. Nos. 5,888,672; 7,129,005 and 7,198,870. Each of the aforementioned patents is incorporated by reference herein in its entirety.

According to some embodiments, the base polymer material may comprise a polymer selected from the group consisting of: polyvinylidene fluoride (PVDF), polyurethane, polyethylene oxide, polyacrylonitrile, polymethylmethacrylate, polyacrylamide, polyvinyl acetate, polyvinylpyrrollidinone, polytetraethylene glycol diacrylate, copolymers of any of the foregoing, and combinations thereof.

According to some embodiments, the electrolyte solvent can comprise one or more organic esters of carbonic acid with the linear or cyclic structure, namely, dialkyl and alkene carbonates, that are used virtually exclusively for this purpose.

According to some embodiments, the electrolyte solvent can comprise ethylene carbonate (EC) which has a cyclic structure and one or more dialkyl carbonates which have a linear structure. Exemplary dialkyl carbonates include dimethyl carbonate (DMC), diethyl carbonate (DEC), and ethylmethyl carbonate (EMC). The mixed solvent composition can be supplemented by ethers or carboxylic esters with various structures, but the latter play the secondary role.

Table 2 below shows the key properties and the structures of the main components of mixed electrolyte solvents which can be used. The ionic conductivity (σ) of a lithium-salt solution in a mixed solvent should be at the level of (1−10)×10−3 S cm-1 near room temperature which provides a lithium ion battery that can operate at temperatures from −30 to +60° C.

TABLE 2

| Name | Structure | T [symbol] °C. | T [symbol] °C. | [symbol] (25 °C.) |
|---|---|---|---|---|
| Ethylene carbonate (EC) | 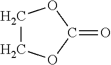 | 36.4 | 248 | 89.78 |
| Propylene carbonate (PC) | 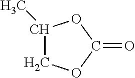 | −48.8 | 242 | 64.92 |
| Dimethyl carbonate (DMC) | 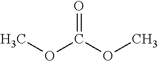 | 4.6 | 91 | 3.107 |
| Diethyl carbonate (DEC) | 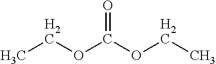 | −74.3 | 126 | 2.805 |
| Ethylmethyl carbonate (EMC) | 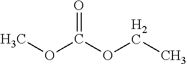 | −53 | [symbol] 0 | 2.9 [symbol] 8 |

[symbol]

indicates data missing or illegible when filed

Exemplary electrolyte solutions include mixtures of alkyl carbonates including ethylene carbonate (EC), dimethyl carbonate (DMC), diethyl carbonate (DEC), and ethyl-methyl carbonates (EMC) and LiPF6 as the electrolyte solution. Preferably included in this group are solvents that are non-flammable, such as tetramethyl phosphate (TMP).

Studies have shown that a highly concentrated mixture of lithium bis(trifluoromethanesulfonyl)amide (LiTFSA, LiN(SO2CF3)2) and urea (both are solids at room temperature) behave like a room temperature molten salt. Similar systems based on LiTFSA salt with urea derivatives, acetamide, and 2-oxazolidinone can also be used.

An electrolyte system comprising Li[CF3SO2)2N] (LiTFSI), one of the lowest lattice energy salts, and 1,3-dioxolane (DOL): dimethoxyethane (DME) (1:1 by volume) as an electrolyte solvent can be used. According to some embodiments, this electrolyte system can be used for Li batteries comprising sulfur as a cathode active material (i.e., Li—S batteries).

According to some embodiments, the electrolyte solution can be prepared by dissolving a lithium salt (e.g., LiPF6) into a binary or ternary solvent which is a mixture of ethylene carbonate (EC) and a non-cyclic carbonate such as dimethyl carbonate (DMC), ethyl (methyl) carbonate (EMC) or diethyl carbonate (DEC).

According to some embodiments, propylene carbonate (PC) can be used as an electrolyte solvent for nonaqueous electrolyte for lithium ion battery, especially for low temperature operation, because of its low melting point (about −48.8° C.), which can lower the eutectic point of solvent with EC. Unfortunately, PC is not widely used as a component of solvent in lithium ion batteries, since PC can easily decompose on graphite electrode surface and co-insert into graphite electrode with lithium ions, which makes graphite electrode exfoliate significantly and reduces the reversible capacity of graphite electrode or even causes the cycling performance of graphite electrode to lose capacity.

Methyl propyl carbonate (MPC) solutions containing Li salts can be used as a single-solvent electrolyte without addition of ethylene carbonate (EC). Graphite electrodes can be cycled at high reversible capacity in MPC solutions containing LiPF6 and LiAsF6. The use of acyclic, unsymmetric alkyl carbonate solvents, such as ethyl methyl carbonate (EMC) and MPC in Li-ion based electrolytes, increases the stability of the graphite electrode. Whereas a small amount of EC is still needed as cosolvent in EMC solutions to obtain stable surface films on graphite electrodes, surface films produced on graphite in MPC solutions (without added EC) can be highly stable, allowing reversible Li-ion intercalation. To understand this trend, we investigated the surface chemistry developed on lithium and carbon electrodes in MPC solutions in conjugation with electrochemical studies.

Some room temperature ionic liquid containing quaternary ammonium cations and imide anions were prepared and electrochemically evaluated and compared to conventional room temperature ionic liquid system with 1-ethyl-3-methylimidazolium cations. The capability of the salt as an electrolyte base of lithium battery system was explained at least in part by the cathodic stability of the salt. However, other properties might also have an effect. An exemplary non-limiting salt of this type includes N-methyl-N-propylpiperidinium bis(trifluoromethanesulfonyl)imide.

Several salts inspired by LiPF6 and LiBF4 have been synthesized in recent years in an attempt to design salts with improved thermal, ionic or other properties. For example, there was an evolution from anions comprised of ligands around a central atom (e.g., PF6-, ClO4-) to large complex anions e.g. bis(trifluoromethanesulfonyl)imide (TFSI or sometimes TFSA) and organic ligand based anions e.g. bis(oxalate)borate (BOB). One category of Li-salts comprehensively studied for LIBs contains sulfonyl groups. Triflate is the simplest anion in this family, while imide-based anions with two x-fluorosulfonyl (x=1−5) groups like bis(fluorosulfonyl)imide (FSI), TFSI, and bis(perfluoroethanesulfonyl)imide (BETI or sometimes PFSI) have recently attracted more attention. The common issue with these anions is the aluminum corrosion by their electrolytes, but a proper electrolyte solvent or additive can be applied to reduce the corrosion. Also, two new Li-salts of this family, lithiumcyclo-difluoromethane-1,1-bis(sulfonyl)imide (LiDMSI) and lithium-cyclo-hexafluoropropane1,1-bis(sulfonyl)imide (LiHPSI) have been reported to form a stable SEI on a graphite anode and passivate an Al current collector significantly better than LiTFSI. Other derivations include compounds combining both a mixture of chemical components for these larger bulk anion components such as tris(pentafluoroethyl)trifluorophosphate (FAP), inspired and derived from PF6-, a family of perfluoroalkyltrifluoroborates CnF(2n+1)BF3 where n=1-4, as alternatives to BF4-, and lithium difluoro(oxalato)borate (LiDFOB), with its combination of different ligands of fluorine and oxalate. Any of these salts can be used in the PME described herein.

According to some embodiments, lithium bis(fluorosulfonyl)imide (LiFSI) can be used as a lithium salt for lithium-ion batteries. Pure LiFSI salt shows a melting point of 145° C., and is thermally stable up to 200° C. It exhibits far superior stability towards hydrolysis than LiPF6. Among the various lithium salts studied at the concentration of 1.0 M (=mol dm-3) in a mixture of ethylene carbonate (EC)/ethyl methyl carbonate (EMC) (3:7, v/v), LiFSI shows the highest conductivity in the order of LiFSI>LiPF6>Li[N(SO2CF3)2] (LiTFSI)>LiClO4>LiBF4.

Bis(oxalato)borate (BOB) and more recent F-free anions such as tetracyanoborate (Bison) and dicyanotriazolate (DCTA or sometimes TADC) are interesting candidates for LIBs. These examples have distinct and unique advantages, but also suffer from issues that have prevented them from replacing LiPF6. The BOB anion is known to take part in forming interphases on both the anode and cathode to improve cell performance, but LiBOB has limited solubility in most aprotic solvents. Bison and DCTA both have high thermal stabilities, but relatively low oxidation potentials and low ionic conductivities of their Li-salt electrolytes. There have been attempts to improve the properties of these salts by adding F species at the expense of increased safety risks and production costs. Several borate-based anions have been synthesized including bis(fluoromalonato)borate (BFMB) to tune the properties of the BOB anion. Similarly, dicyano-trifluoromethyl-imidazole (TDI) and dicyano-pentafluoroethylimidazole (PDI) as well as other imidazole or benzimidazole based anions have shown to be more promising compared to DCTA.

The cathode of batteries as described herein includes a cathode or positive active material. Various exemplary cathode active materials are described below. The following description is not intended to be limiting and other cathode active materials can be used.

According to some embodiments, the cathode active material can be a compound of the following general formula LixNiaMnbCocO, where x ranges from about 0.05 to about 1.25, c ranges from about 0.1 to about 0.4, b ranges from about 0.4 to about 0.65, and a ranges from about 0.05 to about 0.3.

According to some embodiments, the cathode active material can be a compound of the following general formula LixAyMaM′bO2, where M and M′ are at least one member of the group consisting of iron, manganese, cobalt and magnesium; A is at least one member of the group consisting of sodium, magnesium, calcium, potassium, nickel and niobium; x ranges from about 0.05 to 1.25; y ranges from 0 to 1.25, M is Co, Ni, Mn, Fe; a ranges from 0.1 to 1.2; and b ranges from 0 to 1.

According to some embodiments, the cathode active material can be an olivine compound represented by the general formula LixAyMaM′bPO4, where M and M′ are independently at least one member of the group consisting of iron, manganese, cobalt and magnesium; A is at least one member of the group consisting of sodium, magnesium, calcium, potassium, nickel and niobium; x ranges from about 0.05 to 1.25; y ranges from 0 to 1.25; a ranges from 0.1 to 1.2; and b ranges from 0 to 1. According to some embodiments, M can be Fe or Mn. According to some embodiments, the olivine compound is LiFePO4 or LiMnPO4 or combinations thereof. According to some embodiments, the olivine compounds are coated with a material having high electrical conductivity such as carbon. According to some embodiments, the coated olivine compounds can be carbon-coated LiFePO4 or carbon-coated LiMnPO4.

According to some embodiments, the cathode active material can be a manganate spinel represented by an empirical formula of LiMn2O4.

According to some embodiments, the cathode active material can be a spinal material represented by the general formula LixAyMaM′bO4, where M and M′ are independently at least one member of the group consisting of iron, manganese, cobalt and magnesium; A is at least one member of the group consisting of sodium, magnesium, calcium, potassium, nickel and niobium; x is from about 0.05 to 1.25; y is from 0 to 1.25; a is from 0.1 to 1.2; and b ranges from 0 to 1.

According to some embodiments, the lithium ion batteries can use a positive electrode active material that is lithium rich relative to a reference homogenous electroactive lithium metal oxide composition. While not wanted to be limited by theory, it is believed that appropriately formed lithium-rich lithium metal oxides have a composite crystal structure in which, for example, Li2MnO3 is structurally integrated with either a layered LiMnO2 component or a spinel LiMn2O4 component or similar composite compositions with the manganese ions substituted with other transition metal ions with equivalent oxidation states. In some embodiments, the positive electrode material can be represented in two component notation as xLiMO2.(1-x)Li2M′O3 where M is one or more of trivalent metal ions with at least one ion being Mn3+, Co3+, or Ni3+ and where M′ is one or more tetravalent metal ions and 0<x<1.

According to some embodiments, the lithium ion batteries can use a positive electrode active material selected from the group consisting of sulfur, polysulfur, and an active material comprising sulfur in the form of at least one of a sulfide of the metal and a polysulfide of the metal.

The cathodes or positive electrodes employed in batteries of this invention can include a sulfur-based material having a relatively low equivalent weight. The electrodes, which may be composites, include in their theoretically fully charged state sulfur and an electronically conductive material. At some state of discharge, the positive electrode can include one or more of sulfides and polysulfides, which are sulfides and polysulfides of the metal or metals found in the negative electrode. According to some embodiments, the fully charged electrode may also include some amount of such sulfides and/or polysulfides.

The anode of batteries as described herein include an anode or negative active material. Various exemplary anode active materials are described below. The following description is not intended to be limiting and other anode active materials can be used.

The negative or anode active material can include any material allowing lithium to be inserted in or removed from the material. Examples of such materials include carbonaceous materials, for example, non-graphitic carbon, artificial carbon, artificial graphite, natural graphite, pyrolytic carbons, cokes such as pitch coke, needle coke, petroleum coke, graphite, vitreous carbons, or a heat treated organic polymer compound obtained by carbonizing phenol resins, furan resins, or similar, carbon fibers, and activated carbon. According to some embodiments, metallic lithium, lithium alloys, and an alloy or compound thereof can be used as the negative active materials. The metal element or semiconductor element used to form an alloy or compound with lithium may be a group IV metal element or semiconductor element including, but not limited to, silicon or tin (e.g., amorphous tin that is doped with a transition metal). According to some embodiments, the anode active material comprises an amorphous tin or silicon doped with graphite or any of the aforementioned carbonaceous materials, cobalt or iron/nickel. According to some embodiments, the anode material can comprise oxides allowing lithium to be inserted in or removed from the oxide at a relatively low potential. Exemplary oxides include, but are not limited to, iron oxide, ruthenium oxide, molybdenum oxide, tungsten oxide, titanium oxide, and tin oxide. Silicon oxides and nitrides can also be used as the negative active materials.

According to some embodiments, the negative or anode active material can comprise lithium titanate (LTO).

According to some embodiments, glass matrix negative electrodes such as Li/SnO and Li/SiO may also be employed in the batteries of the present invention.

While the foregoing specification teaches the principles of the present invention, with examples provided for the purpose of illustration, it will be appreciated by one skilled in the art from reading the above disclosure that various changes in form and detail can be made without departing from the true scope of the invention.

What is claimed is:

1. A rechargeable lithium battery comprising:
an anode comprising an anode binder polymer and an anode active material;
a cathode comprising a cathode binder polymer and a cathode active material; and
a polymer-matrix electrolyte (PME) comprising an electrolyte polymer, a lithium salt and an electrolyte solvent and/or plasticizer;
wherein the polymer-matrix electrolyte is between the anode and the cathode and directly contacts the anode and cathode to form a battery cell; and
wherein the polymer-matrix electrolyte interpenetrates into the adjacent anode and cathode to form an integral structure.

2. The battery of claim 1, wherein the electrolyte solvent comprises an alkyl carbonate.

3. The battery of claim 1, wherein the electrolyte solvent comprises one or more of ethylene carbonate, dimethyl carbonate, diethyl carbonate, ethyl-methyl carbonate, methyl propyl carbonate, dimethylacetamide (DMAc), dimethoxyethane (DME), a non-flammable solvent, and combinations thereof.

4. The battery of claim 1, wherein the lithium salt comprises on or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃ SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI) and lithium bis(oxalato)borate (LiBOB).

5. The battery of claim 4, wherein the lithium salt is LiPF₆ or Li(CF₃SO₂)₂N.

6. The battery of claim 1, wherein the cathode active material is selected from the group comprises one or more of:
a compound of the following general formula LiₓNiₐMn_{b}Co_{c}O, where x is from about 0.05 to about 1.25, c is from about 0.0 to about 0.4, b is from about 0.0 to about 0.65, and a is from about 0.05 to about 1.0;
a compound of the following general formula LiₓA_{y}MₐM′_{b}O₂, where M and M′ are at least one member of the group consisting of iron, manganese, cobalt, aluminum and magnesium; A is at least one element selected from the group consisting of sodium, magnesium, calcium, potassium, nickel and niobium; x is from about 0.05 to 1.25; y is from 0 to 1.25, M is Co, Ni, Mn, Fe; a ranges from 0.1 to 1.2; and b ranges from 0 to 1;
an olivine compound represented by the general formula LiₓA_{y}MₐM′_{b}PO₄, where M and M′ are independently at least one member of the group consisting of iron, manganese, cobalt and magnesium; A is at least one member of the group consisting of sodium, magnesium, calcium, potassium, nickel and niobium; x is from about 0.05 to 1.25; y is from 0 to 1.25; a is from 0.1 to 1.2; and b is from 0 to 1;
a manganate spinel compound represented by an empirical formula of LiMn₂O₄; and
a spinal compound represented by the general formula LiₓA_{y}MₐM′_{b}O₄, where M and M′ are independently at least one member of the group consisting of iron, manganese, cobalt and magnesium; A is at least one element selected from the group consisting of sodium, magnesium, calcium, potassium, nickel and niobium; x is from about 0.05 to 1.25; y is from 0 to 1.25; a is from 0.1 to 1.2; and b is from 0 to 1.

7. The battery of claim 1, wherein the cathode active material is an olivine compound represented by the general formula:
LiₓA_{y}MₐM′_{b}PO₄;
wherein M is Fe or Mn.

8. The battery of claim 7, wherein the cathode active material comprises LiFePO₄ or LiMnPO₄ or combinations thereof.

9. The battery of claim 7, wherein the cathode active material comprises carbon-coated LiFePO₄ or carbon-coated LiMnPO₄.

10. The battery of claim 1, wherein the anode active material comprises one or more of:
carbonaceous materials;
carbonaceous materials doped with silicon or tin;
metallic lithium, a lithium alloys or a lithium compound;
amorphous tin doped with cobalt or iron/nickel;
an oxide selected from the group consisting of: iron oxide, ruthenium oxide, molybdenum oxide, tungsten oxide, titanium oxide and tin oxide;
silicon oxides; and
silicon nitrides.

11. The battery of claim 10, wherein the anode active material is a carbonaceous material.

12. The battery of claim 10, wherein the anode active material comprises one or more of: non-graphitic carbon, artificial carbon, artificial graphite, natural graphite, pyrolytic carbons and activated carbon.

13. The battery of claim 10, wherein the anode active material comprises a compound of lithium and silicon or tin.

14. The battery of claim 1, wherein the anode active material is graphite and wherein the cathode active material is a compound of the following general formula:
LiₓNi_{y}CoₐMn_{b}O₂
wherein x is from about 0.05 to 1.25;
y is from 0 to 1.25;
a is from 0.1 to 1.2; and
b is from 0 to 1.

15. The battery of claim 1, wherein the anode active material is LiNi_{0.5}Co_{0.2}Mn_{0.3}O₂.

16. The battery of claim 1, wherein the electrolyte polymer, the cathode binder polymer and the anode binder polymer are each independently selected from the group comprising one or more of: a fluorocarbon polymer; a polyacrylonitrile polymer; polyphenylene sulfide (PPS); poly(p-phenylene oxide) (PPE); a liquid crystal polymer (LCP); polyether ether ketone (PEEK); polyphthalamide (PPA); polypyrrole; polyaniline; polysulfone; an acrylate polymer; polyethylene oxide (PEO); polypropylene oxide (PPO); poly(bis(methoxy-ethoxy-ethoxide))-phosphazene (MEEP); polyacrylonitrile (PAN); polymethylmethacrylate (PMMA); polymethyl-acrylonitrile (PMAN); poly(ethylene glycol) diacrylate (PEGDA); a polyimide polymer; co-polymers including monomers of these polymers; and mixtures of these polymers.

17. The battery of claim 16, wherein each of the electrolyte polymer, the cathode binder polymer and the anode binder polymer comprise one or more of: polyvinylidene fluoride (PVDF) and polyvinylidene-co-hexafluoropropylene (PVDF-HFP) and combinations thereof.

18. The battery of claim 16, wherein each of the electrolyte polymer, the cathode binder polymer and the anode binder polymer comprise a mixture of a fluorocarbon polymer and a polyimide.

19. The battery of claim 18, wherein each of the electrolyte polymer, the cathode binder polymer and the anode binder polymer comprise a mixture of polyvinylidene fluoride (PVDF) and a polyimide.

20. The battery of claim 1, wherein:
the cathode active material is LiNi_{0.5}Co_{0.2}Mn_{0.3}O₂;
the anode active material is graphite;
the lithium salt is LiPF₆ or Li(CF₃SO₂)₂N;
the electrolyte solvent comprises one or more of ethylene carbonate, dimethyl carbonate, diethyl carbonate, ethyl-methyl carbonate, methyl propyl carbonate, dimethylacetamide (DMAc), dimethoxyethane (DME) and combinations thereof; and
each of the electrolyte polymer, the cathode binder polymer and the anode binder polymer independently comprises a fluorocarbon polymer, a polyimide or a combination thereof.
